(19) United States
(12) Patent Application Publication
(10) Pub. No.: US 2005/0004754 A1
(43) Pub. Date: Jan. 6, 2005

(54) Navigation method and apparatus for learning and updating position of street address

(76) Inventor: David Hayes, Los Angeles, CA (US)

Correspondence Address: MURAMATSU & ASSOCIATES, Suite 225, 7700 Irvine Center Drive, Irvine, CA, 92618, US

(21) Appl. No.: 10/614,492

(22) Filed: Jul. 3, 2003

(51) Int. Cl. G01C 21/34

(52) U.S. Cl. 701/209; 340/995.19

(57) ABSTRACT

A navigation method and apparatus is capable of learning and updating a street address thereby more precisely matching a position of destination with a street address of the destination based on a difference between the actual arrival position and the calculated position of the destination. The navigation method includes the steps of: producing an assumed position of a destination based on an address number on a street; detecting an arrival at an actual position of the destination; examining a difference between the assumed position of the destination and the actual position of the destination; and updating address data using the difference so as to match the street address number of the destination with the actual position of the destination. The foregoing process is conducted by a single navigation system.

### FIELD OF THE INVENTION

This invention relates to a navigation method and apparatus for navigation system, and more particularly, to a navigation method and apparatus which is capable of learning and updating a street address thereby more precisely matching a position of destination with a street address number of the destination based on a difference between the actual arrival position and the calculated position of the destination.

### BACKGROUND OF THE INVENTION

A navigation system performs travel guidance for enabling a user to easily and quickly reach the selected destination. A typical example is a vehicle navigation system where a navigation system is installed in a vehicle, a portable navigation device such as a hand-held device with a positioning function, and the like. Such a navigation system detects the position of the user or user's vehicle, reads out map data pertaining to an area at the current vehicle position from a data storage medium, for example, a CD-ROM (compact disc read-only memory), a DVD (digital versatile disc), or a hard disc. Alternatively, such map data can be provided to the user from a remote server through a communication network such as Internet. The navigation system displays a map image on a monitor screen while superimposing a mark representing the current location of the user on the map image.

When a destination is set, the navigation system starts a route guidance function for setting a guided route from the start point to the destination. To determine the guided route to the destination, the navigation system calculates and determines an optimum route to the destination based on various parameters. For example, the guided route is determined based on the shortest way to reach the destination, the route preferring freeways to surface roads, the least expensive way to the destination, or the route without using toll road, and the like.

During the route guidance, the navigation system reads the nodes data from the data storage medium such as DVD and successively stores the nodes data of road segments (expressed in longitude and latitude) constituting the guided route in a memory. In the actual traveling, the node series stored in the memory is searched for a portion of the guided route to be displayed in a map display area of the monitor screen, and the portion of the guided route is highlighted so as to be discriminable from other routes. When the vehicle is within a predetermined distance of an intersection it is approaching, an intersection guidance diagram (an enlarged or highlighted intersection diagram with an arrow indicating the direction in which the vehicle is to turn at the intersection) is displayed to inform a user of the desired one of roads or directions selectable at the intersection. Such route guidance by the navigation system is also given by voice instruction.

FIGS. 1A-1H show an example of overall procedure and screen display involved in the navigation system. FIG. 1A shows an example of locator map screen of the navigation system typically used when the destination is not specified. The navigation system displays a street on which the vehicle (current vehicle position VP) is running on a map image and a name of the street. Other information such as a north pointer NP, a map scale and a current time may also be illustrated on the display screen.

FIGS. 1B-1F show an example of process for specifying a destination in the navigation system. When selecting a “Destination” menu on a main menu screen of FIG. 1B, the navigation system displays an “Find Destination By” screen as shown in FIG. 1C for specifying an input method for selecting the destination. The “Find Destination By” screen lists various methods for selecting the destination. The methods include “Address” for specifying the city and address of the destination, “Intersection” for specifying the names of two streets which intersect with one another, and “Point of Interest” (POI) for selecting the programmed destination based on the name, category or telephone number. Other methods in the “Find Destination By” screen include “Recent Route” for specifying the destination based on the recent history of destinations saved in the navigation system, “Address Book” for selecting the address of the destination out of the prescribed address list stored in the system, and “Today's Plan” for selecting two or more destinations.

When selecting, for example, the “Address” method in FIG. 1C, the navigation system displays a keyboard screen in FIG. 1D. Suppose the user inputs an address “2525 W. Carson” of a “Del Amo” shopping mall, the navigation system displays a “Confirm Destination” screen such as shown in FIG. 1E. If the name and address on the screen shows the correct destination, the user enters an “OK to Proceed” key to proceed to the next procedure.

In FIG. 1F, the navigation system calculates and determines a route to the destination, i.e., the address “2525 W. Carson”. The navigation system determines a route to the destination based on, for example, the quickest way to reach the destination, the route using many free ways as possible or the route without using toll road, and the like. In this example, the navigation system displays a progress scale of the calculation of the route.

Once the route to the destination is determined, the navigation system starts the route guidance as shown in FIG. 1G for guiding the user to the destination. Typically, the navigation system shows the intersection which is highlighted to show the next turn and a direction of the turn. Such route guidance by the navigation system is also accompanied by voice instructions. By approaching every intersection to turn, the navigation system automatically displays the intersection guidance diagram to instruct the user which direction to turn at the intersection.

The navigation system measures a distance to the current destination to detect whether the destination is within a predetermined range such as within 100 meters. When the user approaches the destination within such a predetermined distance, the navigation system indicates that the destination “Dest” is ahead as shown in FIG. 1H. The navigation system detects the actual arrival at the destination based on various factors.

In the foregoing process, the point which the navigation system indicated as the destination may not exactly be an actual position of the destination intended by the user. For example, in the conventional navigation system, the position of the destination calculated by the system sometimes does not match the actual position of the street address. This is because the map information does not always include an accurate position of street address for each and every address number on the street.

Such a situation is shown in FIGS. 2A-2C where FIG. 2A shows the address distribution on “Carson W. Street” in the above example of FIGS. 1A-1H which is assumed by the navigation system and FIG. 2B shows an example of actual address distribution on the street of FIG. 2A. For example, as shown in FIG. 2A, the navigation system assumes that the address numbers on “Carson W. Street” are spread evenly, i.e., with a constant interval, along the street between the lowest address number and the highest number. Thus, the address number “2525 Carson W. Street” in FIGS. 1A-1H is assumed to be at the location shown in FIG. 2A.

However, since the actual address numbers are assigned irregularly as shown in FIG. 2B, the actual position (arrival position) of the destination is different from the position of FIG. 2A by a distance d. Therefore, a user may be confused when the navigation system announces the arrival at the incorrect position on the street. FIG. 2C shows another example of actual address distribution where address numbers on the street in a residential area is proportionally assigned while the address numbers on the street in a park, field or vacant land are assigned unevenly, i.e., by an irregular interval.

Therefore, there is a need for a navigation system which is able to improve the performance in interpreting an address number of a destination based on the past record so that the actual position of the destination in the next travel to the same destination can be determined more accurately.

### SUMMARY OF THE INVENTION

It is, therefore, an object of the present invention to provide a navigation method and apparatus which is able to learn and update address information to improve accuracy in determining a position of the destination.

In order to achieve this object, the navigation system learns the relationship between the address number given in the map data and an actual position of the destination which is informed by arrival detection. Thus, the navigation system stores the updated address data regarding the relationship between the street address number and the actual position for use in the next travel.

More specifically, the navigation method for guiding a user to a destination is comprised of steps of: producing an assumed position of a destination based on an address number on a street indicating an address of the destination; detecting an arrival at an actual position of the destination; examining a difference between the assumed position of the destination and the actual position of the destination; and updating address data using the difference so as to match the street address number of the destination with the actual position of the destination.

The navigation method further includes the steps of: storing the updated address data in a memory; and reading the updated address data from the memory when an address on the same street is specified as a destination for determining a position of the destination. More specifically, the navigation method further includes the steps of: storing the updated address data in a memory; and reading the updated address data from the memory when an address on the same street is specified as a destination; and determining a position of the destination by evenly allocating address numbers on the street using the updated address data.

Preferably, the step of detecting the arrival at the destination includes a step of detecting the arrival with use of parameters including whether a vehicle is stationary for longer than a predetermined time length. Alternatively, the step of detecting the arrival at the destination includes a step of receiving an arrival signal in response to a key operation by a user.

The navigation method is able to display a destination mark more accurately by further comprising the steps of: calculating a position of a destination mark by using the updated address data when a destination on the same street is specified; and displaying the destination mark at the calculated position on a map image on a navigation system screen. In the process of updating the address data, the navigation method includes a step of changing a position of a large compound assumed by an address of the large compound to a position of an entrance of the large compound.

In the process of determining the position of the destination includes steps of: selecting two adjacent address numbers on both sides of the specified address where at least one position of the address numbers has been corrected in the updated address data; and calculating a position of the destination by evenly allocating address numbers on the street between the two positions on the street indicated by the two adjacent address numbers; and guiding a user to the position of the destination determined by the calculation step.

Another aspect of the present invention is a navigation apparatus for a guiding the user to the destination. The navigation apparatus is constituted by various means for achieving the navigation method described above which learns the difference between the position of the destination assumed based on street address number and the actual position of the destination and updates the address data based on the difference.

According to the present invention, the navigation system detects the arrival at the actual position of the destination, and the navigation system checks the difference between the assumed position and the actual position and updates the address data for the next use. The updated address data is stored and is retrieved for determining the position of the destination more accurately. Thus, when the user goes to the same destination or other destination on the same street, the navigation system is able to guide the user to the destination more accurately. Further, in the case where a destination is a large compound such as a shopping mall, the navigation system updates the address data so that the street address number of the shopping mall matches the position of an entrance of the shopping mall.

### BRIEF DESCRIPTION OF THE DRAWINGS

FIGS. 1A-1H are schematic diagrams showing an example of process and screen display of a navigation system for specifying a destination, determining a route to the destination, and guiding a user to the destination.

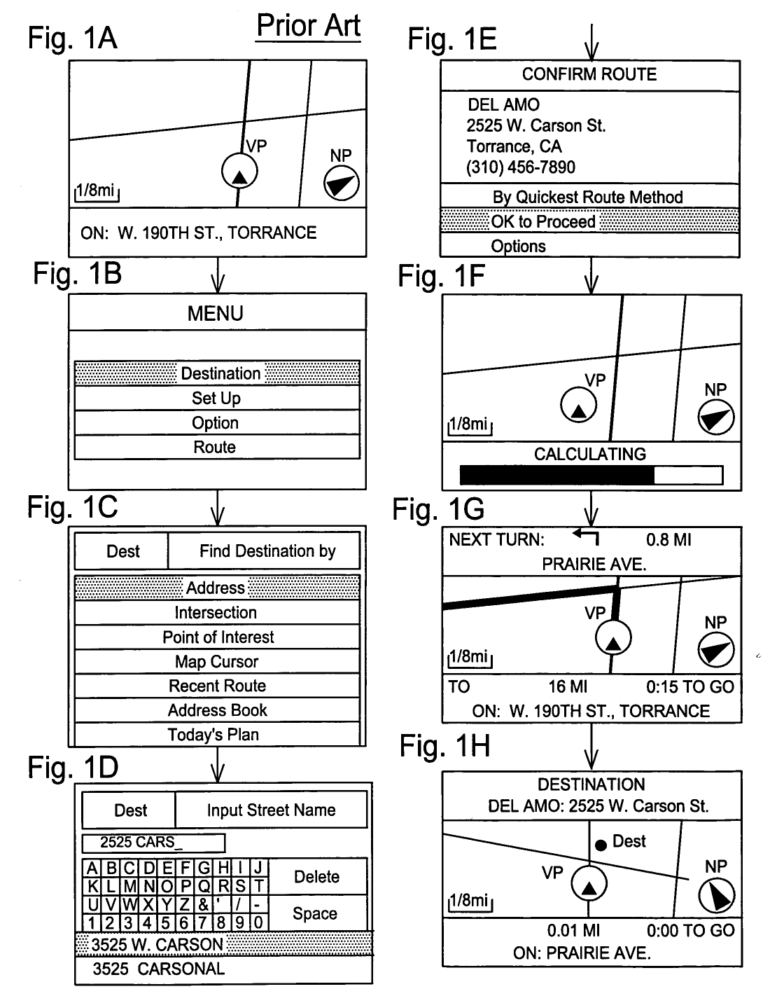

FIGS. 2A-2C are schematic diagram showing a difference between the address number allocation presumed by the navigation system and the actual address number allocation.

FIG. 3 is a block diagram showing an example of structure of a vehicle navigation system implementing the display method and apparatus of the present invention.

FIGS. 4A-4B are schematic diagrams showing an example of outer appearance of a remote controller accompanied by the navigation system of FIG. 3.

FIG. 5 is a block diagram showing an example of structure of the navigation apparatus for learning and updating the street address position in the present invention.

FIGS. 6A-6B are schematic diagrams showing an example of process and display screen for indicating the arrival by the navigation system of the present invention when the vehicle position comes close to the destination.

FIG. 7 is a flow chart showing an example of operation in learning and updating address data for accurately determining the position indicated by the address number of the destination in the present invention.

FIGS. 8A-8E are schematic diagrams showing the concept of learning the actual position of the destination indicated by the address number and updating the correct position by computing address distribution for use in the next travel involved in the same street.

FIGS. 9A-9B are schematic diagrams showing an example of application of the present invention where a position of a large compound such as a shopping mall indicated by a street address number is modified by the navigation system of the present invention.

### DETAILED DESCRIPTION OF THE INVENTION

The present invention will be described in detail with reference to the accompanying drawings. The navigation system in the present invention is designed to determine a location of the destination by learning and updating an actual position of the destination and an address number of the destination. In order to achieve this object, the navigation system learns the relationship between the address number given in the map data and an actual position of the destination which is informed by arrival detection. Thus, the navigation system stores the updated address data regarding the relationship between the street address number and the actual position for use in the next travel.

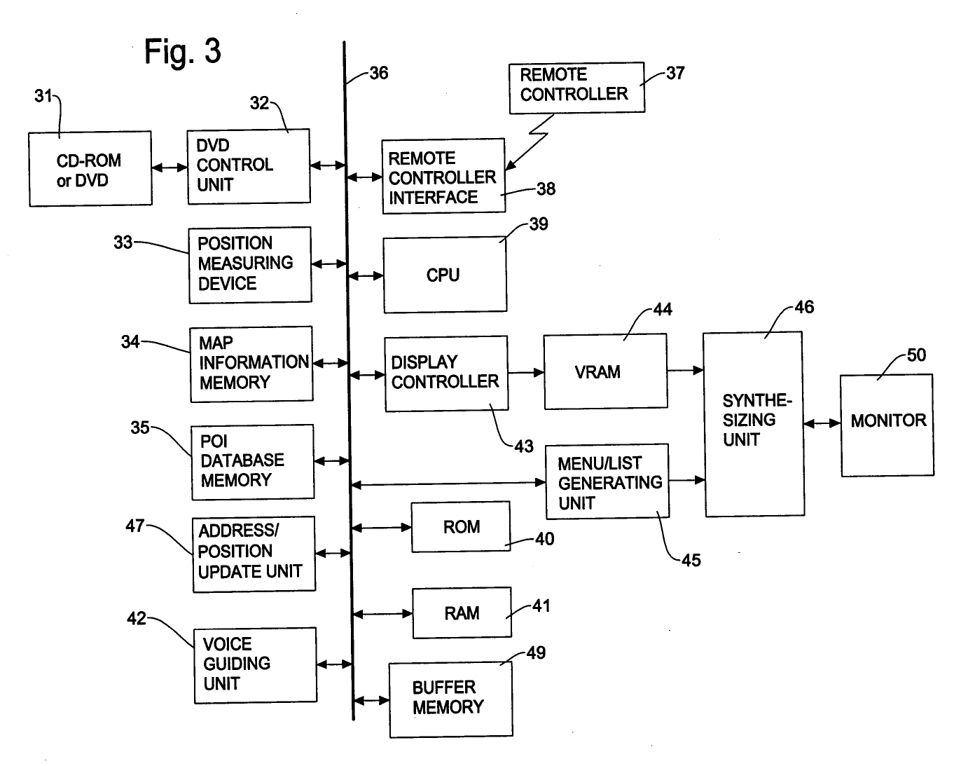

FIG. 3 shows a structure of a vehicle navigation system for implementing the present invention. While the vehicle navigation system is explained for an illustration purpose, the present invention can also be applied to other types of navigation system such as a portable navigation device implemented by a PDA (personal digital assistant) device or other hand-held devices.

In the block diagram, the navigation system includes a map storage medium 31 such as a CD-ROM, DVD, hard disc or other storage means (Hereafter “DVD”) for storing map information, a DVD control unit 32 for a controlling an operation for reading the map information from the DVD, a position measuring device 33 for measuring the present vehicle position or user position. For example, the position measuring device 33 has a vehicle speed sensor for detecting a moving distance, a gyroscope for detecting a moving direction, a microprocessor for calculating a position, a GPS (Global Positioning System) receiver, and etc.

The block diagram of FIG. 3 further includes a map information memory 34 for storing the map information which is read from the DVD 31, a database memory 35 for storing database information such as point of interest (POI) information which is read out from the DVD 31, a remote controller 37 for executing a menu selection operation, an enlarge/reduce operation, a destination input operation, etc. and a remote controller interface 38.

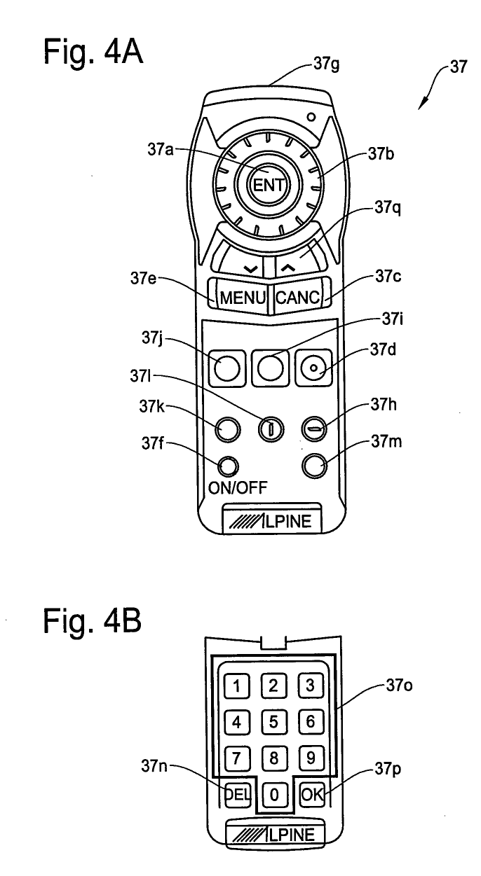

The remote controller 37 has a variety of function keys as shown in FIG. 4A and numeric keys as shown in FIG. 4B. The numeric keys appear when a lid in the lower part of FIG. 4A is opened. The remote controller 37 includes a joystick/enter key 37a, a rotary encoder 37b, a cancel key 37c, an MP/RG key 37d, a menu key 37e, a zoom/scroll key 37q, a monitor ON/OFF key 37f, a remote control transmitter 37g, a plan key 37h, an N/H key 37i, a voice key 37j, a list key 37k, a detour key 37l, a delete destination key 37m, a delete key 37n, numeric keys 37o, and an OK key 37p.

The joystick/enter key 37a selects highlighted items within the menu and moves map displays and a vehicle position icon. The rotary encoder 37b changes zoom scale, scrolls list pages, moves the cursor, and etc. The cancel key 37c cancels the present displayed screen or is operated when returning the screen to the previous menu screen. The MP/RG key 37d toggles between detailed map display and basic guide display during guidance. The menu key 37e displays the main menu. The plan key 37h starts the route guidance including two or more destinations, the N/H key 37i changes between North-up and Heading-up orientation, and the voice key 37j initiates voice instruction.

Although a remote controller such as described above is a typical example for selecting menus, executing selected functions and etc., the navigation system includes various other input methods to achieve the same and similar operations done through the remote controller. For example, the navigation system includes hard keys and a joystick on a head unit of the navigation system mounted on a dash board, touch screen of the display panel, and voice communication means.

Referring back to FIG. 3, the navigation system further includes a bus 36 for interfacing the above units in the system, a processor (CPU) 39 for controlling an overall operation of the navigation system, a ROM 40 for storing various control programs such as a route search program and a map matching program necessary for navigation control, a RAM 41 for storing a processing result such as a guide route, a voice interface and guiding unit 42 for voice communication interface and spoken instructions, a display controller 43 for generating map image (a map guide image and an arrow guide image) on the basis of the map information, a VRAM 44 for storing images generated by the display controller 43, a menu/list generating unit 45 for generating menu image/various list images, a synthesizing unit 46, and a monitor (display) 50.

An address and position updating unit 47 and a buffer memory 49 perform a function of the present invention for correcting a relationship between an address number on a street and an actual position of the destination. The address and position updating unit 47 reads out the address position data from the map information memory 34 to compute the position of the destination. By learning the actual location of the destination and updating the location indicated by the address number to the actual location of the destination, the navigation system records the updated address data in the buffer memory 49. Thus, the navigation system is able to more accurately detect the position of the destination by the address number in the next travel to the same destination or other destination on the same street.

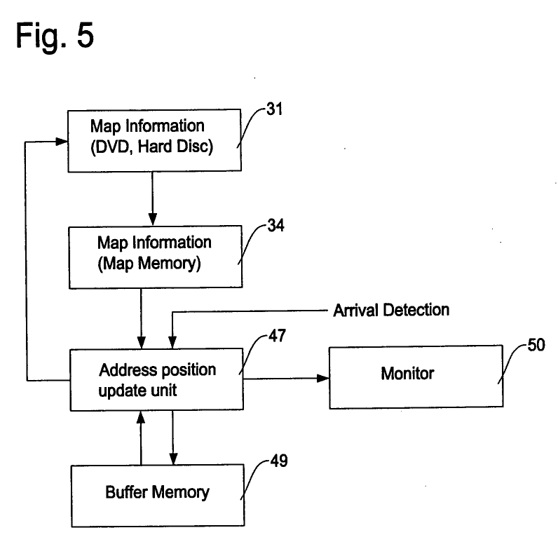

FIG. 5 shows an example of simplified structure of the navigation apparatus for learning and updating the street address position in the present invention. In this block diagram, the components in the structure of FIG. 3 which are directly involved in the operation of the present invention are shown for illustrating the structure of the present invention. The navigation apparatus of FIG. 5 includes the map storage medium 31 such as a DVD or hard disc, map information memory 34, address position updating unit 47, buffer memory 49 and monitor 50.

The map storage medium 31 stores the map information encompassing, for example, all over the country. The map memory 34 extracts the map information from the map storage medium 31 repeatedly by an amount necessary when traveling along the route to the destination. The map information is displayed on the monitor 50 during the route guidance process. When the arrival at the destination is detected automatically by the navigation system or by an arrival notice initiated by the user, an arrival detection signal is sent to the address position updating unit 47.

The arrival detection updating unit 47 checks the difference between the actual position of the destination and the position of the destination originally estimated by the navigation system based on the address number. The estimated position is corrected to the actual position for the address number and the updated (corrected) address data is stored in the buffer memory 49. The updated address data can be stored in the map storage medium 31 if it is a hard disc. Therefore, in the next travel to the same destination or a destination on the same street, the updated address position data is extracted from the buffer memory 49 (or hard disc 31), so that the position of the destination can be determined more accurately.

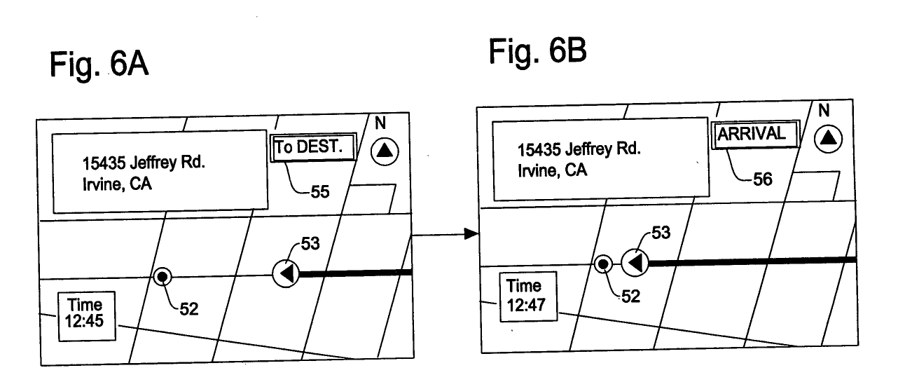

FIGS. 6A-6B show how the actual arrival position of the destination is informed by the arrival detection automatically determined by the navigation system or an arrival signal by the user. FIG. 6A is a display example before the vehicle arrives at the destination. A mark “To DEST.” 55 indicates that the vehicle is still moving toward the destination 52. As shown in FIG. 6A, the current vehicle position 53 is still apart from the destination 52 because the vehicle has not reached the destination.

FIG. 6B shows a display example where the vehicle has arrived at the destination and the user sends the arrival signal to the navigation system. This operation is done by, for example, pressing the enter key 37a. Alternatively, the navigation system can automatically detect the arrival with use of various factors. As shown in FIG. 6B, an “ARRIVAL” mark 56 is displayed. Then, the navigation system stores the current vehicle position 53 as the correct position of the destination address in the map information memory 34.

In most cases, the position of the displayed destination mark 52 does not match the actual destination address because the street address numbers in the map data are very limited and the most destination addresses are not included. The navigation system learns the actual position of the destination and updates the position indicated by the address number. The updated address data is stored in the buffer memory 49, then, the navigation system can use the updated address data in the next time.

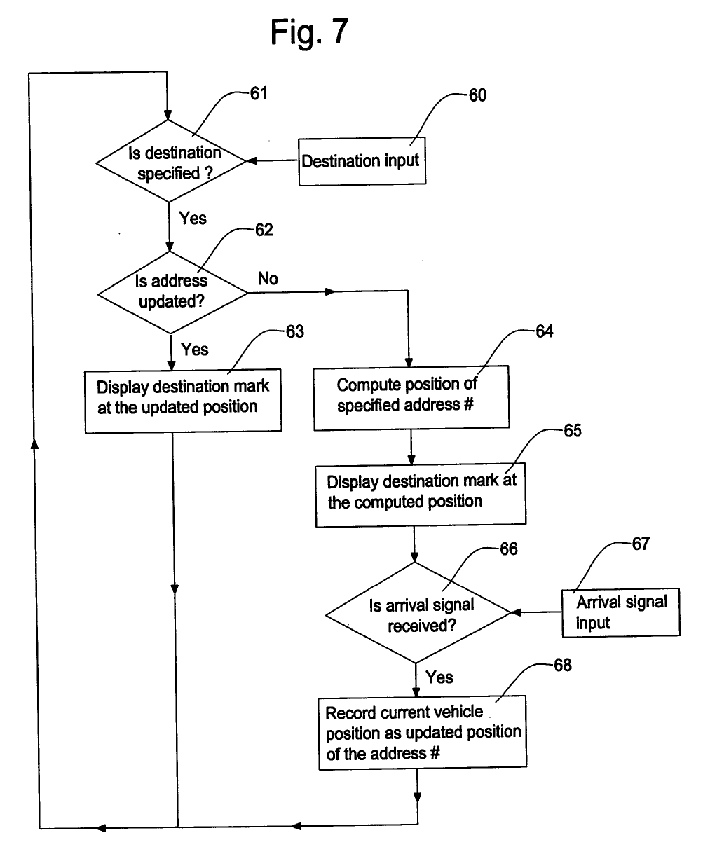

FIG. 7 is an example of a flow chart showing the process for learning and updating the street address position in the present invention. In FIGS. 6A and 6B, the present invention is explained for the case in which a destination mark is displayed more accurately on the navigation screen. Not only to such an effect, but also to improve the performance of guiding the user to the accurate location of the destination, the navigation system in the present invention keeps learning the actual position of the destination and updating the street address data.

In FIG. 7, first, the navigation system waits for a destination input at step 61. In general, the destination is specified by the user using one or more search methods provide by the navigation system. If a destination is specified in step 60, the navigation system checks whether the specified destination address was used in the past and the address data regarding the actual destination position at the address number was updated. If the address data is the one updated before, at step 63, the navigation system utilizes the updated address data and displays a destination mark on the street position based on the updated data and guides the user to the destination.

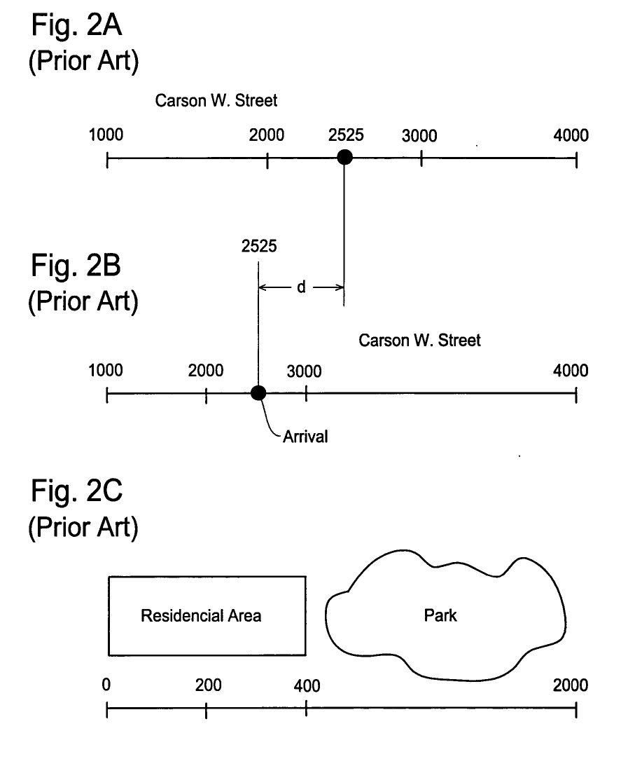

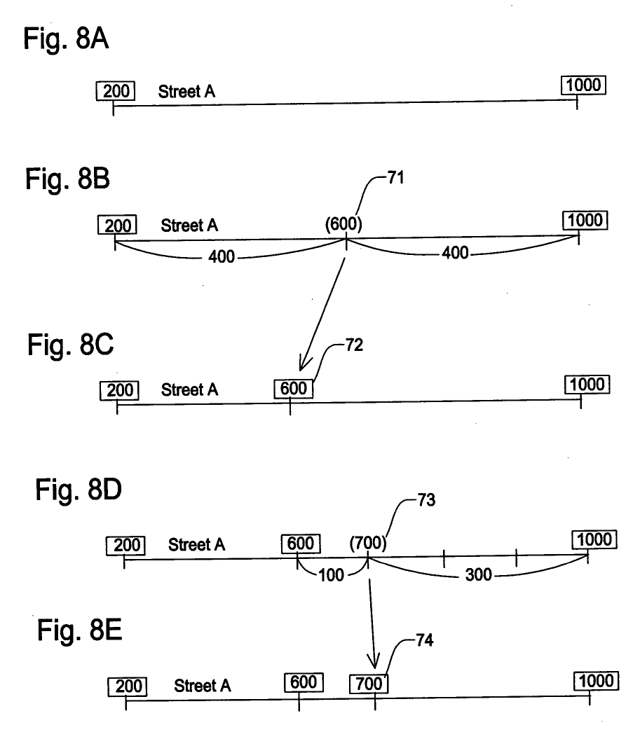

Otherwise, the position of the destination address has to be computed at step 64 based on the conventional method in which the location of the destination is determined by allocating the street numbers evenly on the street. An example of conventional method for computing the position of the destination is shown in FIG. 2A where the navigation system assumes that the address numbers are allocated with a constant interval along the street. FIGS. 8A-8E also show the address allocation and address correction in the present invention as will be explained later.

After computing the position of the destination, the navigation system displays a destination mark at the computed position of the address at step 65 and starts the route guidance to the destination. When the vehicle arrives at the destination, at step 66, the navigation system detects the arrival or receives an arrival signal based on the instruction by the user. For example, the navigation system detects the arrival based on various parameters such as whether the vehicle is stationary for longer than a predetermined time length or whether the vehicle has made a turn (to enter a parking lot, etc). Other parameters include use of parking brake, use of turn signal, user of reverse drive, whether the vehicle is on a street segment or off street segment, etc.

If the arrival signal is entered at step 67, the navigation system checks the difference between the actual position of the destination and the position of the destination assumed by the navigation system when the destination is specified. As noted above, at first, the navigation system assumed that the address numbers on the street are evenly distributed. Thus, if the navigation system detects the difference between the actual position and the assumed position, it records the corrected information on the address number to indicate the actual position of the destination in the buffer memory in step 68.

In this manner, more accurate position of the destination is recorded with the address number on the street. Thus, in the next travel to the same destination, or other destination on the same street, the navigation system is able to determine the accurate position of the destination and guide the user to the destination more accurately with use of the updated address data. Further, the navigation system can display a destination mark more accurately at the correct position on the screen.

FIGS. 8A-8E show how the navigation system determines the address number distribution and updates the address information on a street segment based on the actual position of the destination. The navigation system uses the updated address information for computing the position of the destination in the next occasion. In FIG. 8A, it is supposed that the street segment “Street A” is defined by nominal street address numbers “200” and “1,000” at two ends. Because the two address numbers are assigned to the actual two locations, the address numbers and the actual positions match with one another. Then, assume that a street address number “600” is now specified by the user as a destination (step 60 in FIG. 7). Because the street address 600 is not defined with respect to an actual location on the street in the map data, the navigation system assumes the location by evenly (proportionally) distributing the address numbers between the locations of address numbers 200 and 1,000.

Thus, the navigation system computes and determines the position of the address 600 as shown in FIG. 8B where the position 71 of the street address 600 is at the middle of the addresses 200 and 1,000. This is because the navigation system computes the position of the destination by dividing the street segment with a constant interval: a distance 400 between the addresses 200 and 600 and a distance 400 between the addresses 600 and 1,000. This situation is the same as that described with reference to FIG. 2A.

However, in reality, the address numbers are not always evenly distributed along the street as shown in FIG. 2B or FIG. 8C. Thus, when the vehicle reaches the destination, the actual position 72 of the street address 600 differs from the presumed position as shown in FIGS. 8B and 8C. Then, the navigation system records the current vehicle position as the correct position of the street address number 600. Accordingly, on the street A, three positions for the address numbers 200, 600 and 1,000 are now known as accurate positions. The navigation system stores the updated address data for these positions in the buffer memory 49 (FIGS. 3 and 5). Thus, when the user specifies the same address number 600 on the street A again, the navigation system is able to guide the user to the actual position of the destination based on the updated address data.

Now, suppose that the user specifies the street address number 700, since the actual position of this address is not known, the navigation system computes the position of the street address 700 with use of the updated address data. First, the navigation system selects two adjacent street address numbers on the both sides of the destination address, in this example, the addresses numbers 600 and 1,000. Then, the navigation system computes the position 73 of the destination by evenly dividing the street segment into four as shown in FIG. 8D.

Since the position of the address number 600 is accurate because of the updated address data of FIG. 8C, an actual position of the destination “1700 Street A” assumed in the process of FIG. 8D is more accurate than that would be made by the conventional method of FIG. 8B. Thus, in FIG. 8E, the position of the destination calculated by the navigation system almost matches the actual (correct) position 74 of the destination. Then, the navigation system records the actual position of the street address number 700 as updated address data. Similarly, in the case where an address number between 200 and 600 on the street A is specified as a destination, the navigation system finds the position of the specified destination by allocating the address numbers equally between the address numbers 200 and 600. In this manner, the navigation system updates the address data every time there is a discrepancy between the assumed destination position and actual destination position.

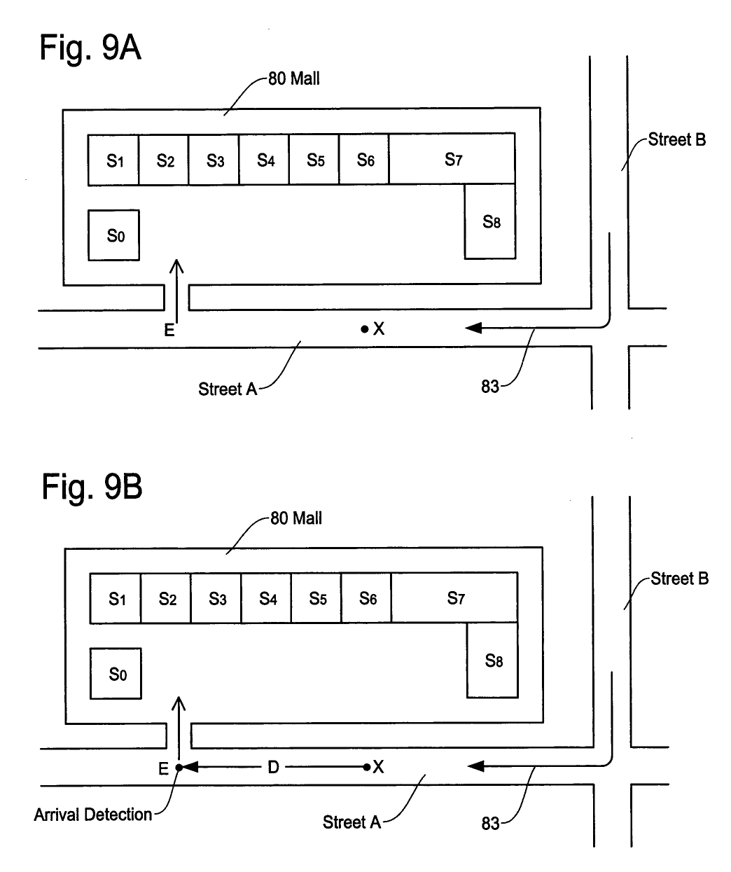

FIGS. 9A-9B are schematic diagrams showing an example of application of the present invention where a position of a large compound such as a shopping mall expressed by an street address number is modified by the navigation system of the present invention. In the map information currently available for the navigation system, an address of a shopping mall or other large compound is given by one street address number. For example, as shown in FIG. 9A, the address of a shopping mall 80 is expressed in the map information by an address number X on a street A. Thus, when guiding the user to the shopping mall 80 with stores S0-S8, the navigation system determines the position of the shopping mall 80 at the address number X on the street A.

However, even if the position of the address X may be accurate, the user has to go to an entrance E of the shopping mall 80. In other words, when the user drives along the route 83, it is not practical if the navigation system indicates the arrival at the destination with respect to the position X. In such a situation, even though it may be inaccurate, it is more convenient for the user that the navigation system updates the position of the shopping mall 80 to the position E for the street address number X.

Thus, in FIG. 9B, when the arrival is detected at the entrance E, the navigation system takes the difference D between the position expressed by the address number X and the entrance E of the shopping mall 80 into consideration and updates the address data. The updated address data is stored in the buffer memory 49 which is retrieved in the next occasion of going to the shopping mall 80. Thus, in the next travel to the shopping mall 80, the navigation system determines the position of the street address number X to the position of the entrance E rather than the position X.

As has been described in the foregoing, the navigation system detects or the user informs the arrival to the actual position of the destination, and the navigation system checks the difference between the assumed position and the actual position and updates the address data for the next use. The updated address data is stored and is retrieved for determining the position of the destination more accurately. Thus, when the user goes to the same destination or other destination on the same street, the navigation system is able to guide the user to the destination more accurately. Further, in the case where a destination is a large compound such as a shopping mall, the navigation system updates the address data so that the street address number of the shopping mall matches the position of an entrance of the shopping mall.

Although the invention is described herein with reference to the preferred embodiments, one skilled in the art will readily appreciate that various modifications and variations may be made without departing from the spirit and the scope of the present invention. Such modifications and variations are considered to be within the purview and scope of the appended claims and their equivalents.

1. A navigation method for guiding a user to a destination, comprising the following steps of:
producing an assumed position of a destination based on an address number on a street indicating an address of the destination;
detecting an arrival at an actual position of the destination;
examining a difference between the assumed position of the destination and the actual position of the destination; and
updating address data using the difference so as to match the street address number of the destination with the actual position of the destination;
wherein all of the foregoing steps are conducted by a single navigation system.

2. A navigation method as defined in claim 1, further comprising the following steps of:
storing the updated address data in a memory; and
reading the updated address data from the memory when an address on the same street is specified as a new destination for determining a position of the new destination.

3. A navigation method as defined in claim 1, further comprising the following steps of:
storing the updated address data in a memory; and
reading the updated address data from the memory when an address on the same street is specified as a new destination; and
determining a position of the new destination by evenly allocating address numbers on the street using the updated address data.

4. A navigation method as defined in claim 1, wherein said step of detecting the arrival at the destination includes a step of detecting the arrival with use of parameters including whether a vehicle is stationary for longer than a predetermined time length.

5. A navigation method as defined in claim 1, wherein said step of detecting the arrival at the destination includes a step of receiving an arrival signal in response to a key operation by a user.

6. A navigation method as defined in claim 1, further comprising the steps of:
calculating a position of a destination mark by using the updated address data when a destination on the same street is specified; and
displaying the destination mark at the calculated position on a map image on a navigation system screen.

7. A navigation method as defined in claim 1, wherein said step of updating the address data includes a step of changing a position of a large compound assumed by an address of the large compound to a position of an entrance of the large compound.

8. A navigation method as defined in claim 3, wherein said step of determining the position of the destination includes the steps of:
selecting two adjacent address numbers on both sides of the specified address of the new destination where at least one position of the address numbers has been corrected in the updated address data; and
calculating a position of the new destination by evenly allocating address numbers on the street between the two positions on the street indicated by the two adjacent address numbers; and
guiding a user to the position of the new destination determined by said calculation step.

9. A navigation apparatus for guiding a user to a destination, comprising:
means for producing an assumed position of a destination based on an address number on a street indicating an address of the destination;
means for detecting an arrival at an actual position of the destination;
means for examining a difference between the assumed position of the destination and the actual position of the destination; and
means for updating address data using the difference so as to match the street address number of the destination with the actual position of the destination;
wherein all of the foregoing means are incorporated in a single navigation system.

10. A navigation apparatus as defined in claim 9, further comprising:
means for storing the updated address data in a memory; and
means for reading the updated address data from the memory when an address on the same street is specified as a new destination for determining a position of the new destination.

11. A navigation apparatus as defined in claim 9, further comprising:
means for storing the updated address data in a memory; and
means for reading the updated address data from the memory when an address on the same street is specified as a new destination; and
means for determining a position of the new destination by evenly allocating address numbers on the street using the updated address data.

12. A navigation apparatus as defined in claim 9, wherein said means for detecting the arrival at the destination includes means for detecting the arrival with use of parameters including whether a vehicle is stationary for longer than a predetermined time length.

13. A navigation apparatus as defined in claim 9, wherein said means for detecting the arrival at the destination includes means for receiving an arrival signal in response to a key operation by a user.

14. A navigation apparatus as defined in claim 9, further comprising:
means for calculating a position of a destination mark by using the updated address data when a destination on the same street is specified; and
means for displaying the destination mark at the calculated position on a map image on a navigation system screen.

15. A navigation apparatus as defined in claim 9, wherein said means for updating the address data includes means for changing a position of a large compound assumed by an address of the large compound to a position of an entrance of the large compound.

16. A navigation apparatus as defined in claim 12, wherein said means for determining the position of the destination includes:
means for selecting two adjacent address numbers on both sides of the specified address of the new destination where at least one position of the address numbers has been corrected in the updated address data; and
means for calculating a position of the new destination by evenly allocating address numbers on the street between the two positions on the street indicated by the two adjacent address numbers; and
means for guiding a user to the position of the new destination determined by said calculation means.
